(19) United States
(12) Patent Application Publication
(10) Pub. No.: US 2014/0280339 A1
(43) Pub. Date: Sep. 18, 2014

(54) INTEGRATING OFFERS

(71) Applicant: MICROSOFT CORPORATION, Redmond, WA (US)

(72) Inventors: VAIBHAV JAIN, BELLEVUE, WA (US); SWAPNIL PALOD, REDMOND, WA (US); MANOJ KUMAR, BELLEVUE, WA (US)

(73) Assignee: MICROSOFT CORPORATION, REDMOND, WA (US)

(21) Appl. No.: 13/799,813

(22) Filed: Mar. 13, 2013

(51) Int. Cl. G06F 17/30

(52) U.S. Cl. CPC G06F 17/30522
USPC 707/775

(57) ABSTRACT

Methods, computer systems, and computer-storage media are provided for generating offers. Offers may be generated upon being associated with one or more of a keyword, a search query input, a search query history for a user, a current trend, a social trend (either user-specific or not user-specific social trends), a user location, and the like. Upon determining the association between one or more offers and at least one of the above-listed factors, the one or more relevant offers may be displayed in a variety of ways including, but not limited to, in conjunction with search results, on an offers portal dedicated to presentation of offers, in a mapping application of a mobile device, and the like.

### BACKGROUND

Conventionally, unearthing offers online is a cumbersome and tedious process. A user may be required, in order to locate an offer for a particular retailer or product, to locate a list of potential web sites that provide offers for the retailer and/or product. Then, the user may need to manually locate a specific offer for the retailer and/or product on each individual site associated with each offer. Additionally, sites that provide said offers are typically not updated properly and may contain invalid, closed, and non-existing offers.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Embodiments of the present invention relate to systems, methods, and computer-storage media for, among other things, generating offers. More specifically, embodiments of the present invention seek to integrate offers into applications that are readily accessible to users including, for instance, a search results page. An offers portal (i.e., an offer graphical user interface) may be available for the sole purpose of displaying relevant offers to a user. Said relevant offers may be, as previously mentioned, integrated into other applications such as a search results page of a web browser (e.g., Bing® search results), a map application (e.g., a map application of a mobile device such as a mobile phone), and the like. Relevant offers may be determined based on a variety of factors including, but not limited to, a search query input (i.e., keyword match), search query history, a user's location, current trends, user activity (e.g., a user's activity in a social media forum), and the like.

Accordingly, in one embodiment, the present invention is directed to one or more computer-storage media having computer-executable instruction embodied thereon that, when executed by one or more computing devices, performs a method of generating offers. The method comprises, receiving a search query input from a user; identifying a search query history for the user, wherein the search query history includes one or more search queries previously submitted by the user; comparing one or more of the search query history and the search query input with one or more offers; determining whether at least one offer of the one or more offers is associated with at least one search query of the search query history or the search query input; and upon determining that at least one offer is associated with at least one search query, displaying the at least one offer to the user.

In another embodiment, the present invention is directed to one or more computer-storage media having computer-executable instruction embodied thereon that, when executed by one or more computing devices, performs a method of generating offers. The method comprises identifying one or more trends, wherein a trend is an indication of an area of interest for a majority of users; based on the one or more trends, identifying one or more offers associated with at least one of the one or more trends; and displaying the one or more offers.

In yet another embodiment, the present invention is directed to one or more computer-storage media having computer-executable instruction embodied thereon that, when executed by one or more computing devices, performs a method of generating offers. The method comprises identifying one or more social trends, wherein a social trend is a user-specific activity associated with at least one of a plurality of social media forums; identifying one or more offers associated with the one or more social trends; and displaying the one or more offers, wherein the one or more offers are displayed on a graphical user interface simultaneously with a feed of information from each of the plurality of social media forums.

### BRIEF DESCRIPTION OF THE DRAWINGS

The present invention is described in detail below with reference to the attached drawing figures, wherein:

FIG. 1 is a block diagram of an exemplary computing environment suitable for use in implementing embodiments of the present invention;

FIG. 2 is a block diagram of an exemplary system for generating offers suitable for use in implementing embodiments of the present invention;

FIG. 3 depicts an illustrative screen display, in accordance with an embodiment of the present invention;

FIG. 4 depicts an illustrative screen display, in accordance with an embodiment of the present invention;

FIG. 5 depicts an illustrative screen display, in accordance with an embodiment of the present invention;

FIG. 6 depicts an illustrative screen display, in accordance with an embodiment of the present invention;

FIG. 7 depicts an illustrative screen display, in accordance with an embodiment of the present invention; and

FIGS. 8-10 are flow diagrams of exemplary methods of generating offers in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various aspects of the technology described herein are generally directed to systems, methods, and computer-storage media for, among other things, generating offers. More specifically, embodiments of the present invention seek to integrate offers into applications that are readily accessible to users including, for instance, a search results page. An offers portal (i.e., an offer graphical user interface) may be available for the sole purpose of displaying relevant offers to a user. Said relevant offers may be, as previously mentioned, integrated into other applications such as a search results page of a web browser (e.g., Bing® search results), a map application (e.g., a map application of a mobile device such as a mobile phone), and the like. Relevant offers may be determined based on a variety of factors including, but not limited to, a search query input (i.e., keyword match), search query history, a user's location, current trends, user activity (e.g., a user's activity in a social media forum), and the like.

The term offers, as used herein, generally refers to an indication of a transaction. The offer may include, among other things, a proposed price, a proposed discount, and the like. Offers may comprise coupons and deals. A coupon, as used herein, generally refers to an indicated transaction associated with a product promotional code. A deal, on the other hand, is often times associated with a retailer. For example, a coupon may be sought online for a discount on a product purchased at any number of stores. The promotional code may be entered at any store and the discount may be applied. This is indicative of, for example, a manufacturer's coupon. A deal, however, may or may not be product specific but is retailer specific. An example of this may be a 20% (or any percentage) off deal for Store X. This may be applied to any product at Store X. Embodiments of the present invention are related to integrating coupons, deals, or a combination thereof for a user.

Regardless of whether coupons, deals, or a combination thereof are displayed to a user, the present invention seeks to provide relevant offers in an efficient manner. Various factors may be utilized to determine a relevant offer, as briefly mentioned above and as will be described in further detail below. Additionally, offers are efficiently presented to a user by retrieving the relevant offers without any additional user input. For example, a user may simply input a search query and relevant offers may be displayed with the search results, on an offers portal, or the like. The user is not required to embark on a separate search to locate offers. They are simply identified and presented to the user.

Having briefly described an overview of embodiments of the present invention, an exemplary operating environment in which embodiments of the present invention may be implemented is described below in order to provide a general context for various aspects of the present invention. Referring to the figures in general and initially to FIG. 1 in particular, an exemplary operating environment for implementing embodiments of the present invention is shown and designated generally as computing device 100. The computing device 100 is but one example of a suitable computing environment and is not intended to suggest any limitation as to the scope of use or functionality of embodiments of the invention. Neither should the computing device 100 be interpreted as having any dependency or requirement relating to any one or combination of components illustrated.

Embodiments of the invention may be described in the general context of computer code or machine-useable instructions, including computer-useable or computer-executable instructions such as program modules, being executed by a computer or other machine, such as a personal data assistant or other handheld device. Generally, program modules include routines, programs, objects, components, data structures, and the like, and/or refer to code that performs particular tasks or implements particular abstract data types. Embodiments of the invention may be practiced in a variety of system configurations, including hand-held devices, consumer electronics, general-purpose computers, more specialty computing devices, and the like. Embodiments of the invention may also be practiced in distributed computing environments where tasks are performed by remote-processing devices that are linked through a communications network.

With continued reference to FIG. 1, the computing device 100 includes a bus 110 that directly or indirectly couples the following devices: a memory 112, one or more processors 114, one or more presentation components 116, one or more input/output (I/O) ports 118, one or more I/O components 120, and an illustrative power supply 122. The bus 110 represents what may be one or more busses (such as an address bus, data bus, or combination thereof). Although the various blocks of FIG. 1 are shown with lines for the sake of clarity, in reality, these blocks represent logical, not necessarily actual, components. For example, one may consider a presentation component such as a display device to be an I/O component. Also, processors have memory. The inventors hereof recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

The computing device 100 typically includes a variety of computer-readable media. Computer-readable media may be any available media that is accessible by the computing device 100 and includes both volatile and nonvolatile media, removable and non-removable media. Computer-readable media comprises computer storage media and communication media; computer storage media excluding signals per se. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 100.

Communication media, on the other hand, embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The memory 112 includes computer-storage media in the form of volatile and/or nonvolatile memory. The memory may be removable, non-removable, or a combination thereof. Exemplary hardware devices include solid-state memory, hard drives, optical-disc drives, and the like. The computing device 100 includes one or more processors that read data from various entities such as the memory 112 or the I/O components 120. The presentation component(s) 116 present data indications to a user or other device. Exemplary presentation components include a display device, speaker, printing component, vibrating component, and the like.

The I/O ports 118 allow the computing device 100 to be logically coupled to other devices including the I/O components 120, some of which may be built in. Illustrative I/O components include a microphone, joystick, game pad, satellite dish, scanner, printer, wireless device, a controller, such as a stylus, a keyboard and a mouse, a natural user interface (NUI), and the like.

A NUI processes air gestures, voice, or other physiological inputs generated by a user. These inputs may be interpreted as search prefixes, search requests, requests for interacting with intent suggestions, requests for interacting with entities or subentities, or requests for interacting with advertisements, entity or disambiguation tiles, actions, search histories, and the like presented by the computing device 100. These requests may be transmitted to the appropriate network element for further processing. A NUI implements any combination of speech recognition, touch and stylus recognition, facial recognition, biometric recognition, gesture recognition both on screen and adjacent to the screen, air gestures, head and eye tracking, and touch recognition associated with displays on the computing device 100. The computing device 100 may be equipped with depth cameras, such as, stereoscopic camera systems, infrared camera systems, RGB camera systems, and combinations of these for gesture detection and recognition. Additionally, the computing device 100 may be equipped with accelerometers or gyroscopes that enable detection of motion. The output of the accelerometers or gyroscopes is provided to the display of the computing device 100 to render immersive augmented reality or virtual reality.

Aspects of the subject matter described herein may be described in the general context of computer-executable instructions, such as program modules, being executed by a computing device. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

Furthermore, although the term “server” is often used herein, it will be recognized that this term may also encompass a search engine, a Web browser, a cloud server, a set of one or more processes distributed on one or more computers, one or more stand-alone storage devices, a set of one or more other computing or storage devices, a combination of one or more of the above, and the like.

Referring now to FIG. 2, a block diagram is provided illustrating an exemplary computing system 200 in which embodiments of the present invention may be employed. Generally, the computing system 200 illustrates an environment where offers are generated. Among other components not shown, the computing system 200 generally includes a user device 202, a database 204, a network 206, and an offer engine 208. It is understood and appreciated by those of ordinary skill in the art that the computing system architecture 200 shown in FIG. 2 is merely an example of one suitable computing system and is not intended to suggest any limitation as to the scope of use or functionality of the embodiments of the invention. Neither should the computing system architecture 200 be interpreted as having any dependency or requirement related to any single module/component or combination of modules/components illustrated therein.

The various components of the computing system architecture 200 are connected to each other and in communication with one another via the network 206. The network 206 may include, without limitation, one or more local area networks (LANs) and/or wide area networks (WANs). Such networking environments are commonplace in offices, enterprise-wide computer networks, intranets and the Internet. Accordingly, the network 206 is not further described herein.

Each of the user device 202 and the offer engine 208 shown in FIG. 2 may be any type of computing device, such as, for example, computing device 100 described above with reference to FIG. 1. By way of example only and not limitation, each of the user device 202 and the offer engine 208 may be a personal computer, desktop computer, laptop computer, handheld device, mobile handset, consumer electronic device, or the like. It should be noted, however, that embodiments are not limited to implementation on such computing devices, but may be implemented on any of a variety of different types of computing devices within the scope of embodiments hereof. The offer engine 208 may also include any type of device configurable to perform methods described herein.

Components of the offer engine 208 may include, without limitation, a receiving component 210, an identifying component 220, a comparing component 230, a determining component 240, and a displaying component 250. The offer engine 208 may organize requests for offers and the display thereof. In particular, the offer engine 208 may determine where to display an offer, what type of offer to display, and the like utilizing various components thereof.

The receiving component 210 is configured for, among other things, receiving an input. The input may include, without limitation, a search query input from, for example, a user, a location of a user and/or user device, user activity (e.g., user activity within a social media forum), and the like. The receiving component 210 may be configured to work cooperatively with the identifying component 220. The identifying component 220 is configured for, among other things, identifying various data pieces related to offers or the display thereof. The identifying component 220 may identify, without limitation, a search history of a user, current trends, social trends, advertiser information associated with offers (e.g., bids submitted by advertisers), and the like.

The receiving component 210 and identifying component 220, while depicted as separate components, may be integrated into a single component. In the present invention, it is intended that, whether a single component or multiple components, the receiving component 210 and the identifying component 220 are utilized to receive, identify, retrieve, and gather, etc., any information necessary in the generation of offers.

The comparing component 230 is configured for, among other things, comparing information obtained by one or more of the receiving component 210 and the identifying component 220 with, for example, one or more offers. The one or more offers, and information associated thereto, may be stored in the database 204 as well as in association with one or more components of the offer engine 208. An exemplary embodiment utilizes the comparing component 230 to compare one or more offers with a search history of a user in order to identify relevant offers. This, as well as other exemplary embodiments, will be discussed in detail further below. Alternatively, the comparing component 230 may compare one or more offers to a search query input in order to identify any offers that may be related to the single search query input rather than an entire search history.

Once compared, the determining component 240 may determine whether at least one of the one or more offers is related to the compared information. For instance, in the above example where one or more offers is compared to a user's search history, the determining component 240 may determine whether any of the one or more offers contains information that may be related to, or associated with, the user's search history (or any search query thereof). A keyword comparison may be used as well as contextual analysis. For instance, a keyword comparison may identify any keywords that are present in both the compared information and the one or more offers (e.g., a search query contains the word ‘shoes’ and an offer contains the word ‘shoes’ or is directed to ‘shoes’). Contextual analysis may identify offers that are associated with compared information, even without matching keywords. For instance, a search query input may be ‘hotels in Redmond, Wash.’ and an offer that may be deemed related to the search query input may be to purchase airline tickets to Washington.

Embodiments of the present invention are directed to determining relevant offers based on a user's search history. A user's search history may be identified, for example, from data in the database 204. A user's search history may include a plurality of search query inputs and includes the plurality of search query inputs for a predetermined period of time. For instance, the system 200 may be configured to obtain a search history for a user for the past two days. Alternatively, a search history for a user for the last six hours may be obtained. The system may be configured in any way desired by a system administrator. Offers may be determined relevant to a user's search history using any known methods to determine relevancy. Additionally, the user's search history is configurable by the user. A user can enable or disable it. Thus, a default threshold may be stored in the system to keep a search history for a number of days but a user will have an option to disable that function at any time.

Additional embodiments are directed to determining relevant offers based on current trends. As described above, a trend is an indication of an area of interest for a majority of users. Put a different way, trends are what is popular at any given moment. For instance, a certain news headline may dominate over other news for a given day, certain celebrities may be more popular at some times than others, a movie may be a hot topic on opening day, etc. Additional trends may be social trends. Social trends, as used herein, generally refer to a user-specific activity associated with one or more social media forums. User-specific activity may include a post by a user on a social media forum, an upload by a user on a social media forum, etc. Social trends may also be a non user-specific activity (e.g., public) associated with one or more social media forums. Privacy settings of a social media forum may determine which information a user is presented with. Additionally, information presented also depends on whether a user is logged into a social media forum at the time. Social trends that are not based on user-specific activity, for example, may be displayed when a user is not logged into a social media forum or if privacy settings are set such that certain social media information is not shared. FIG. 5, as will be discussed in greater detail below, illustrates this example. A user-specific social trend, however, may be presented if a user is logged into a social media forum at the time they input a search query. By way of example, the user may be presented with one or more search results as well as a social trends area including one or more relevant activities that are associated with the user. For instance, if a user, who is logged into a social media forum, inputs a search query for the term “xbox” the user may be presented with one or more comments made by various other users regarding an “xbox,” etc.

Offers may be associated with current trends or social trends (user-specific or non user-specific) by identifying one or more offers that contains information relevant to or associated with the trends or social trends. For instance, if a current trend is identified as a big game that is approaching (e.g., a championship football game) then a relevant offer may be directed to a product that is associated with the big game (e.g., apparel for the playing teams, big screen TV's to watch the game, snack foods for during the game, etc.). Another example would be related to social trends; if a user is identified as uploading several photos to a social media forum, a relevant offer may be a discount on a camera (this would be a social trend based on user-specific activity).

Another embodiment may be directed to identifying relevant offers based on a user's location. This embodiment may be utilized most on a mobile device, such as a mobile phone. A physical location of a user and/or user device may be identified using any means known in the art to locate objects. Once a location is identified, relevant offers associated with locations in proximity to the user location may be displayed. In proximity to a user location may be determined by a user administrator and may indicate any predetermined distance (e.g., a number of miles from a user location) desired by an administrator.

Additionally, a map application may be utilized to display one or more offers relevant to a user's search query/results. In other words, a user may search for a term in a map application in order to obtain results for an entire area (e.g., the United States). The user can further drill down the results, for example, by state, city, locality, or the like. Intent may be identified from the user's search. For example, if a user searches for “Flowers Bellevue” then the map application can directly show the Bellevue region in the map and point to flowers within the region. This embodiment is portrayed in FIG. 7. FIG. 7 includes a mobile device 700 having a user interface 702. A user location 704 may be identified and distinguished on the user interface 702. Alternatively, results may be based on a user's search within a map application. A plurality of locations is identified and represented in user interface 702 by a plurality of flags (represented by flag 708) that may be presented near the user location 704. Flag 708 (as well as any other flag associated with a location) may be selectable such that when a user selects flag 708 an offer 706 appears. The offer 706 may include a retailer name, a discount amount, a store location, contact information for the retailer, a selectable link to retrieve the offer, and the like. A selectable link to retrieve the offer may, upon selection, result in the offer being printed, e-mailed to a desired e-mail address, sent as a text message to an indicated device, or the like.

Once relevant or associated offers are identified, the displaying component 250 displays the one or more offers to a user. The one or more offers may be displayed in a variety of ways. For instance, the one or more offers may be displayed simultaneously with one or more search results related to a search query input. FIG. 3 illustrates this embodiment. A user interface 300 is provided including a search query input area 302 and an exemplary search query input 304. In this example, the search query input 304 is “xbox.” Search results are typically provided in response to a search query input and are illustrated by search results 306. Additionally, advertisements 305 deemed relevant to the search query input 304 are displayed in the user interface 300. Based on either a keyword match (i.e., matching the keyword “xbox” with one or more offers) or a search history analysis (i.e., comparing a user's search history with one or more offers) one or more offers 308 are displayed to a user. The one or more offers 308 include offer 310, offer 312, offer 314, and offer 316. A scroll icon 318 is provided when additional offers are available so a user can scroll through the plurality of offers. Offers 310, 312, 314, and 316 each include, without limitation, a retailer identifier 326, an indication of the offer, a selectable link to retrieve the offer depicted by links 322 and 320, and a social media link 324. Link 320 is configured such that selection thereof provides a user with a coupon code associated with the offer. Link 322 is configured such that selection thereof provides a user with a printed copy of the offer. Additional links may be provided that, for example, e-mail an offer to a user, text message an offer to a user, and the like. Social media link 324 is configured such that a user can link an offer to a social media forum. For instance, a user can share the offer with the social media forum such that other users associated with the user can see the offer. Additionally, the user could “like” the offer so that it is posted on the social media forum.

An additional display interface is provided in FIG. 4 as user interface 400. User interface 400 illustrates displayed relevant offers based on current trends. Current trends 410 are illustrated with a plurality of images and/or headlines. For example, an image of a baseball field may be displayed during playoffs. Based on the current trends 410, an offers area 420 illustrates a plurality of offers including offer 421, offer 422, offer 423, and offer 424. Alternatively, the offers area 420 may display one or more offers that are deemed to be popular themselves rather than associated with a current trend. Thus, the offer itself would be a trend. As described with reference to FIG. 3, each of offers 421, 422, 423, and 424 include a retailer identifier 425, a selectable link to retrieve the offer depicted by links 426 and 427, and a social media link 428.

Turning now to FIG. 5, a user interface 500 for displaying offers relevant to non user-specific social trends is provided. Social media information 504 is displayed in user interface 500. Social media information may be filtered using filter links 502 in order to view information for one social media forum or a combination of various social media forums. Indicators 506 and 508 may represent the source of the information 504. For instance, indicator 506 may indicate that the source is Social Media Site A while indicator 508 indicates that the source of that piece of information is Social Media Site B. In embodiments, any type of indicator may be used to depict a source of information.

Trend bar 509 provides a user with a plurality of trends. Each trend in trend bar 509 is selectable such that selection thereof may navigate a user to information related to the selected trend. FIG. 5 illustrates an offers area 510 that presents one or more offers 520, 530, and 540 that are not based on user-specific activity. However, in alternative embodiments, the one or more offers may be based on one or more of the trends bar 509, the social media information 504, or a user's specific activity in a social media forum. As previously described, each of offers 520, 530 and 540 include a retailer identifier 550, a selectable link to retrieve the offer depicted by links 560 and 570, and a social media link 580.

An offers portal is provided in FIG. 6 and illustrated by user interface 600. An offers portal, as used herein, refers generally to an interface dedicated to presenting offers. The offers presented may be relevant to a user based on any one of the above-described factors including, but not limited to, current trends, social trends, a user's location, keyword matches, a user's search history, and the like. User interface 600 may be assumed to display one or more offers relevant to a user's search history if, for example, a user's search history included various search queries related to electronic devices. As shown, offers 602, 604, and 606 each relate to electronic devices. As with the previous interfaces, each of offers 602, 604, and 606 include, among other things, a selectable link to retrieve the offer depicted by links 608 and 612, and a social media link 610. Various filtering schemes may be provided such that a user can filter offers based on a variety of factors including, retailers, products, locations, etc. User interface 600 illustrates various filters with respect to retailers (e.g., a check box is provided to the left of the offers 602, 604, and 606 to filter by retailer as well as a retailer filter provided above the offers 602, 604, and 606.

The offers portal may also display one or more offers based on advertiser information such as bids from the advertisers for the offers. For instance, an offer that is associated with a higher bid may be presented on the offers portal when a very low bid offer may not be presented. Alternatively, both may presented on the offers portal but the offer associated with a higher bid may be presented in a more prominent location such as, for example, the top of a list of offers, or in a location that allows for a larger offer image size. It is important to reiterate that the term offer includes both coupons and deals and, specifically, that the offers portal is configured to present either coupons or deal or a combination or coupons and deals.

In an embodiment, the offers portal displays one or more offers based on a user's personal search history. While this was previously discussed with respect to presenting the offers in combination with a search results page, the offers associated with a user's search history may also be populated in the offers portal such that the offers portal is constantly updating and is populated with the most relevant offers to a user based on their personal search history.

It will be understood by those of ordinary skill in the art that computing system architecture 200 is merely exemplary. While the offer engine 208 is illustrated as a single unit, one skilled in the art will appreciate that the offer engine 208 is scalable. For example, the offer engine 208 may in actuality include a plurality of components in communication with one another. Moreover, the database 204 may be included within the offer engine 208 or user device 202 as a computer-storage medium. The single unit depictions are meant for clarity, not to limit the scope of embodiments in any form.

Turning now to FIG. 8, a flow diagram is depicted of an exemplary method 800 of generating offers. Initially, as indicated at block 802, a search query input is received from a user. At block 804 a search query history for the user is identified. At block 806 one or more of the search query history and the search query input is compared with one or more offers. At block 808 it is determined whether at least one offer is associated with at least one of the search query input or at least one search query of the search query history. At block 810, at least one offer determined to be associated with at least one of the search query input or at least one search query of the search query history is displayed. X

Turning now to FIG. 9, a flow diagram is depicted of an exemplary method 900 of generating offers. Initially, at block 902, one or more trends are identified. A trend, as previously discussed, is an indication of an area of interest for, typically, a majority of users. Based on the one or more trends, one or more offers associated with the one or more trends are identified at block 904 and displayed at block 906.

Turning now to FIG. 10, a flow diagram is depicted of an exemplary method 1000 of generating offers. Initially, at block 1002, one or more social trends are identified. A social trend may be a user-specific activity associated with at least one of a plurality of social media forums. At block 1004 one or more offers associated with the user-specific activity are identified. The one or more offers are displayed at block 1006.

It will be understood by those of ordinary skill in the art that the order of steps explained above are not meant to limit the scope of the embodiments of invention in any way and, in fact, the steps may occur in a variety of different sequences within embodiments hereof. Any and all such variations, and any combination thereof, are contemplated to be within the scope of embodiments of the invention. Alternative embodiments will become apparent to those of ordinary skill in the art to which the embodiments of the invention pertains without departing from its scope.

From the foregoing, this innovation is one well adapted to attain all the ends and objects set forth above, together with other advantages which are obvious and inherent to the system and method. It should be understood that certain features and subcombinations are of utility and may be employed without reference to other features and subcombinations. This is contemplated by and is within the scope of the claims.

What is claimed is:

1. One or more computer-storage media having computer-executable instructions embodied thereon that, when executed by one or more computing devices, perform a method of generating offers, the method comprising:
receiving a search query input from a user;
identifying a search query history for the user, wherein the search query history includes one or more search queries previously submitted by the user;
comparing one or more of the search query history and the search query input with one or more offers;
determining whether at least one offer of the one or more offers is associated with at least one search query of the search query history or the search query input; and
upon determining that at least one offer is associated with at least one search query, displaying the at least one offer to the user.

2. The media of claim 1, wherein the search query history identified is the search query history for a predetermined time period.

3. The media of claim 1, wherein the one or more offers includes a coupon associated with a promotional code.

4. The media of claim 1, wherein the one or more offers includes a deal associated with a retailer.

5. The media of claim 1, wherein the at least one offer is displayed with one or more search results related to the search query input.

6. The media of claim 1, wherein the at least one offer is displayed via an offers portal separate from one or more search results related to the search query input.

7. The media of claim 1, wherein the at least one offer includes a selectable option to retrieve the at least one offer.

8. The method of claim 7, wherein retrieving the at least one offer includes accessing a promotional code associated with the at least one offer.

9. The method of claim 7, wherein retrieving the at least one offer includes one of printing the at least one offer, emailing the at least one offer, or texting the at least one offer.

10. One or more computer-storage media having computer-executable instructions embodied thereon that, when executed by one or more computing devices, perform a method of generating offers, the method comprising:
identifying one or more trends, wherein a trend is an indication of an area of interest for a majority of users;
based on the one or more trends, identifying one or more offers associated with at least one of the one or more trends; and
displaying the one or more offers.

11. The media of claim 10, wherein the area of interest is news headlines.

12. The media of claim 10, wherein the area of interest is entertainment news headlines.

13. The media of claim 10, wherein the area of interest is social media activity.

14. The media of claim 10, wherein the one or more offers includes a coupon associated with a promotional code.

15. The media of claim 10, wherein the one or more offers includes a deal associated with a retailer.

16. One or more computer-storage media having computer-executable instructions embodied thereon that, when executed by one or more computing devices, perform a method of generating offers, the method comprising:
identifying one or more social trends, wherein a social trend is a user-specific activity associated with at least one of a plurality of social media forums;
based on the one or more social trends, identifying one or more offers associated with the one or more social trends; and
displaying the one or more offers, wherein the one or more offers are displayed on a graphical user interface simultaneously with a feed of information from each of the plurality of social media forums.

17. The media of claim 16, wherein the user-specific activity is a post by a user on one of the social media forums.

18. The media of claim 16, wherein the one or more offers includes a selectable link to retrieve the one or more offers.

19. The media of claim 16, wherein the one or more offers includes a coupon associated with a promotional code.

20. The media of claim 16, wherein the one or more offers includes a deal associated with a retailer.
